(19) United States
(12) Patent Application Publication
(10) Pub. No.: US 2008/0129088 A1
(43) Pub. Date: Jun. 5, 2008

(54) SLIDING ROOF SYSTEM

(76) Inventors: Martin Spickermann, Wiesbaden (DE); Detlef Heyn, Kirchhain (DE)

Correspondence Address: CARLSON, GASKEY & OLDS, P.C., 400 WEST MAPLE ROAD, SUITE 350, BIRMINGHAM, MI, 48009, US

(21) Appl. No.: 11/946,896

(22) Filed: Nov. 29, 2007

(30) Foreign Application Priority Data
Dec. 1, 2006 (EP) 06 024 912.5

(51) Int. Cl. B60J 7/22; B60J 7/043

(52) U.S. Cl. 296/217

(57) ABSTRACT

A sliding roof system includes at least one guide rail, a cover that is displaceable relative to the guide rail, and a wind deflector that can be displaced between a lowered and a deployed position. At least two actuating elements act on the wind deflector in order to press the wind deflector out of the deployed position into the lowered position. An offset V is provided such that the sliding roof system is able to have one of the actuating elements act on the wind deflector while the other actuating element remains spaced apart from the wind deflector.

### RELATED APPLICATIONS

The application claims priority to European Application No. 06 024 912.5, which was filed on Dec. 1, 2006.

### BACKGROUND OF THE INVENTION

The invention relates to a sliding roof system with at least one guide rail, a cover that is displaceable relative to the guide rail, a wind deflector that is displaceable between a lowered and a deployed position, and at least two actuating elements that can act on the wind deflector in order to press the wind deflector out of the deployed position into the lowered position.

A wind deflector is usually pushed into a deployed position by a deployment spring. The wind deflector takes up this position when it is not retained in a lowered position by actuating elements. Dimensions of the deployment spring have to be such that the wind deflector cannot be pressed downwards by prevailing wind loads even at a high driving speed but rather remains stably in the deployed position. The actuating elements are usually either fitted on a cover of the sliding roof system, or are on a displacement mechanism for the cover. As a result, the actuating elements are moved towards the wind deflector when the cover is displaced from an open position towards a closed position. The actuating elements are arranged such that, during the closing movement of the cover, the actuating elements automatically press the wind deflector down counter to a spring force of the deployment spring from the deployed into the lowered position. As a result, the wind deflector is pivoted out of a displacement path of the cover, and the cover can close. Rather than a separate drive being necessary for displacing the wind deflector, the displacement movement of the wind deflector results from the displacement of the cover, and is therefore ultimately brought about by a drive for the cover.

A trapping prevention function is provided in modern sliding roof systems that prevents, during closure of the cover, impermissibly high forces being exerted on objects that are located in the path of movement of the cover. One example of such an object is a vehicle occupant's hand. In order to realize the trapping prevention function, in many cases it is provided to monitor current consumption of a driving motor for the cover, or the speed of rotation of the driving motor. If the current consumption exceeds a certain limit value, or the speed of rotation of the driving motor drops below a certain limit value or drops at an excessively high rate, it is interpreted to mean that an obstacle must be situated in the displacement path of the cover. The driving motor is then switched off and, in some cases, operated in an opposite direction, i.e. the cover is moved in an opening direction, in order to release the object which is possibly already trapped.

Since the requirements with regard to reliable trapping protection are increasingly more stringent, ever lower limit values are defined for the current consumption of the driving motor or reduction in the rotational speed of the motor, for example. When these limit values are exceeded, the trapping prevention function responds. This may give rise to a problem caused by the striking of the actuating elements against the wind deflector such that the wind deflector can be displaced out of the deployed into the lowered position counter to the spring force. This contact leads to such an increase in the current consumption of the driving motor, or to such a reduction in speed of rotation, that the trapping prevention function responds and stops the cover, or even displaces the cover slightly towards a more open position. This is obviously undesirable.

Thus, it is desirable to develop a sliding roof system of the type initially mentioned, which can reliably prevent an erroneous response of the trapping prevention function when the wind deflector is displaced from its deployed into the lowered position.

### SUMMARY OF THE INVENTION

A sliding roof of the type initially mentioned includes an offset that reliably prevents an erroneous response of a trapping function. The offset leads to the sliding roof system being able to take up a state in which one actuating element acts on a wind deflector while another actuating element remains spaced apart from the wind deflector. In general terms, the invention is based on the basic concept of splitting an operation to displace the wind deflector from a deployed into a lowered position into two sections that are not, as in the prior art, carried out simultaneously, but rather successively. This leads to the actuating elements, and therefore a driving motor, not suddenly experiencing the overall resistance required to transfer the wind deflector into the lowered position, but rather the resistance is divided into two smaller amounts that act successively. This leads to the rise in current consumption being lower, and also the rotation speed of the motor drops by a smaller amount, and therefore the trapping prevention function does not incorrectly respond.

According to one example, the wind deflector has two coupling arms that are designed to be different from each other to produce the offset. This example has the advantage that the displacement mechanism of the sliding roof system does not have to be modified. Instead, it is sufficient to appropriately modify the separately produced wind deflector. This makes it possible to insert this example design into a current production series.

There are various possibilities of differently designing the two coupling arms of the wind deflector to produce the offset. For example, each coupling arm can be coupled to a guide rail, with the two coupling points being offset in relation to each other, as viewed in a longitudinal direction of the guide rails. Alternatively, one of the coupling arms could also be of a steeper design than the other of the coupling arms in a region that interacts with the actuating element assigned to the respective coupling arm, and therefore the offset is produced when the actuating elements strike against the coupling arms.

According to another example, the actuating elements are fitted on the cover and are offset in relation to each other. In this example, the actuating elements can be small projections on a lower side of the cover in a region of a front edge. Thus, the offset necessary for staggered actuation of the wind deflector can be brought about with little outlay.

According to another example, the actuating elements are fitted displaceably on the guide rails, and are offset in relation to each other. In this example, the actuating elements are designed as separate holding-down devices that can be displaced on the guide rails, and which differ from each other such that the desired offset is obtained when the two coupling arms of the wind deflector are actuated.

Also, a method is provided to displace a wind deflector of a sliding roof system from a deployed position into a lowered position. Two actuating elements are displaced in such a manner that the actuating elements act on the wind deflector and press the wind deflector out of the deployed into the lowered position. First, one of the actuating elements acts on the wind deflector and begins to press the wind deflector in a direction of the lowered position, and only subsequently does the other actuating element also act on the wind deflector in order to press the wind deflector into the lowered position. With regard to the advantages produced by this method, reference is made to the above explanations with regard to the sliding roof system.

These and other features of the present invention can be best understood from the following specification and drawings, the following of which is a brief description.

### BRIEF DESCRIPTION OF THE DRAWINGS

FIG. 1 shows, in a schematic side view, a sliding roof system according to one example of the invention.

FIG. 2 shows, in a bottom view, a cover of the sliding roof system from FIG. 1.

FIG. 3 shows, in an enlarged, broken away view, a front edge of the cover of the sliding roof system from FIG. 1.

FIG. 4 shows, in a perspective view, a sliding roof system according to another example, with the cover not being illustrated for better clarity.

FIG. 5 shows, in a perspective view, a mechanism of the sliding roof system from FIG. 4.

FIG. 6 shows, in a schematic view, a wind deflector for a sliding roof system according to another example of the invention.

FIG. 7 shows, in a side view, a variant of the wind deflector from FIG. 6.

FIG. 8 shows a diagram of rotational speed of a driving motor of a sliding roof system according to the invention and of a conventional sliding roof system, as a function of a displacement path of the cover.

### DETAILED DESCRIPTION OF THE PREFERRED EMBODIMENT

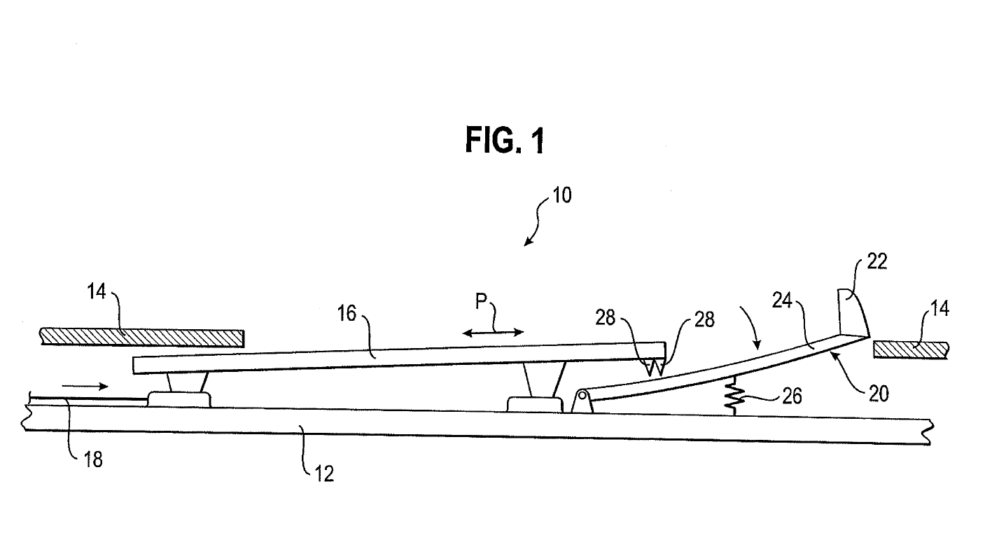

FIGS. 1 to 3 show a sliding roof system 10 that is to be fitted on a roof of a motor vehicle. The sliding roof system 10 has two guide rails 12 that are fitted along edges of an opening in the vehicle roof. Of the vehicle roof, two bodywork sections 14 are shown lying in front of and behind the roof opening, as seen in a direction of travel. A cover 16 that is displaceable by a driving cable 18 and a driving motor (not illustrated) is fitted displaceably on the guide rail 12. A wind deflector 20, which is formed here from a transverse part 22 and two coupling arms 24, is arranged in a region of a front edge of the roof opening. The two coupling arms 24, together with the transverse part 22, have a generally U-shaped design. A deployment spring 26 pushes the wind deflector 20 into a deployed position, as shown in FIG. 1. In this position, the transverse part 22 extends above a roof skin, i.e. above the front bodywork section 14.

The sliding roof system 10 shown could in principle also have more than one cover. The only requirement is that there is a front cover that can press the wind deflector downwards.

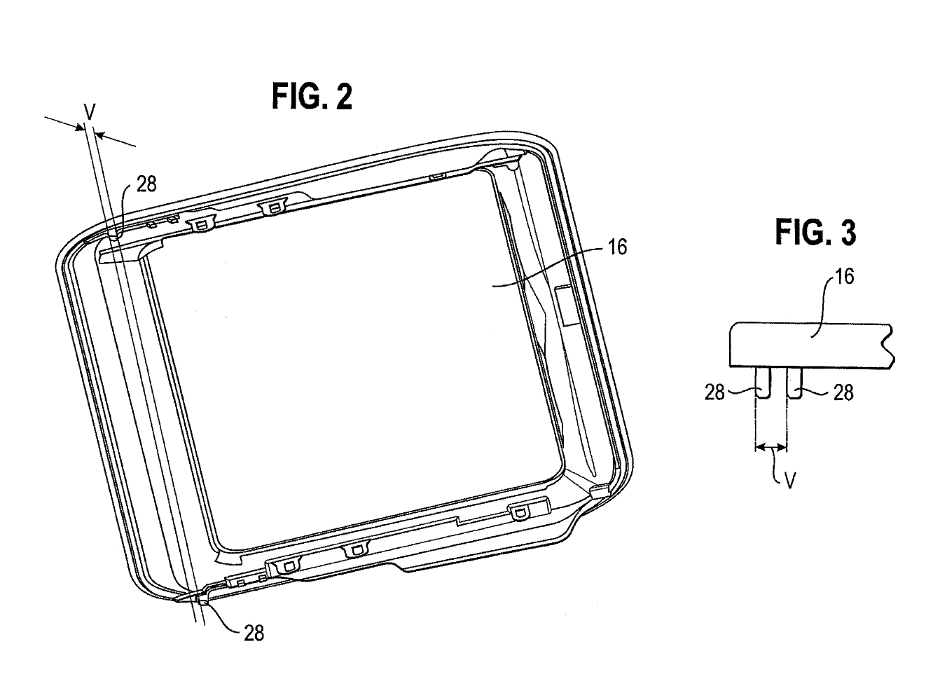

On a lower side of the cover 16, two actuating elements 28 are arranged in a region of the front edge, as seen in the direction of travel of the vehicle, i.e. on the side facing the wind deflector 20 (also see FIG. 2). The actuating elements 28 are designed in the manner of plastic lugs and extend downwardly from the cover 16 by approximately the same amount. It is essential that the two actuating elements 28 are arranged with an offset V in relation to each other, as viewed in the longitudinal direction of the vehicle, and in particular along a displacement direction P of the cover 16. In other words, one of the actuating elements 28 is located further forwards than the other.

The arrangement of the two actuating elements 28 with an offset V relative to each other has the effect that, during closing of the cover 16, i.e. when the cover 16 is moved from the position shown in FIG. 1 to the right to a closed position, the two actuating elements 28 do not strike against the two coupling arms 24 simultaneously, but rather successively. This has the effect that the displacement movement of the cover 16 is first of all resisted just by one coupling arm 24. Only after the cover 16 has been displaced a further distance towards the closed position, which approximately corresponds to the offset V, does the second actuating element 28 also act on the corresponding coupling arm 24 of the wind deflector 20. This has the effect that the cover 16 is not abruptly braked in its movement towards the closed position as occurs when the two actuating elements 28 strike against the two coupling arms 24 of the wind deflector 20 simultaneously, but rather is braked gently.

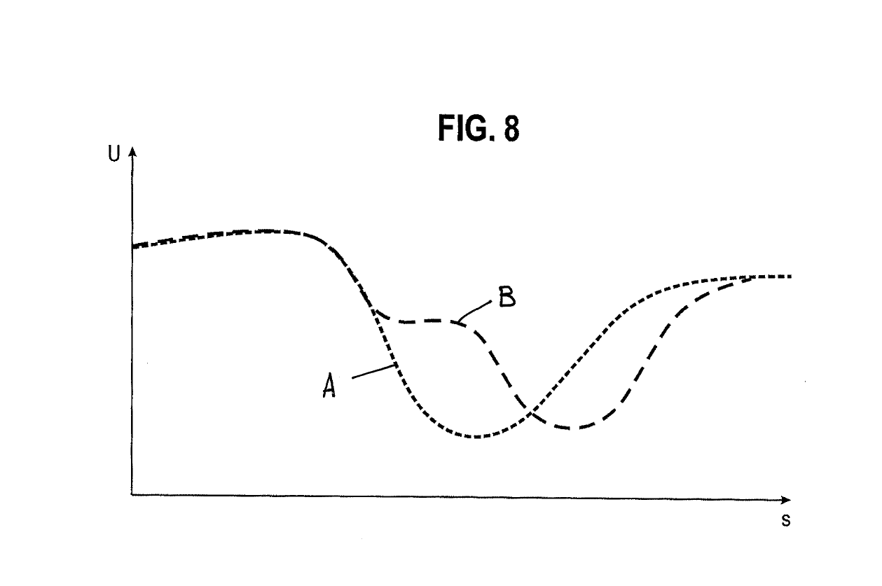

FIG. 8 plots a profile of a rotational speed of the motor U of the driving motor over displacement travels of the cover 16. The dotted line A shows the profile for a sliding roof system according to the prior art, in which the two actuating elements 28 strike against the coupling arms 24 of the wind deflector 20 simultaneously. It can clearly be seen that the motor speed drops greatly. As a result, there is the risk of the trapping prevention function of the sliding roof system incorrectly responding.

The profile of the rotational speed of the motor in the sliding roof system according to the invention is illustrated by the dashed line B. It can be seen that, when the first actuating element 28 strikes against the wind deflector arm assigned to it, the rotational speed of the motor drops by a first amount and only then, when the second actuating element 28 has also reached the coupling arm 24 assigned to it, drops a further time. In this case, the drop in the rotational speed of the motor is significantly less steep than in the case of a sliding roof system according to the prior art. In addition, the rotational speed of the motor drops less, as seen absolutely, than in the case of a system according to the prior art. The risk is therefore reduced of the reduction in the rotational speed of the motor arising from the interaction of the cover with the wind deflector being incorrectly recognized as a hazardous situation by the trapping prevention system.

After the two actuating elements 28 interact with the coupling arms 24 assigned to them, the wind deflector 20 is pressed further downwards in a known manner into a completely lowered position if the cover 16 continues to be moved to the closed position.

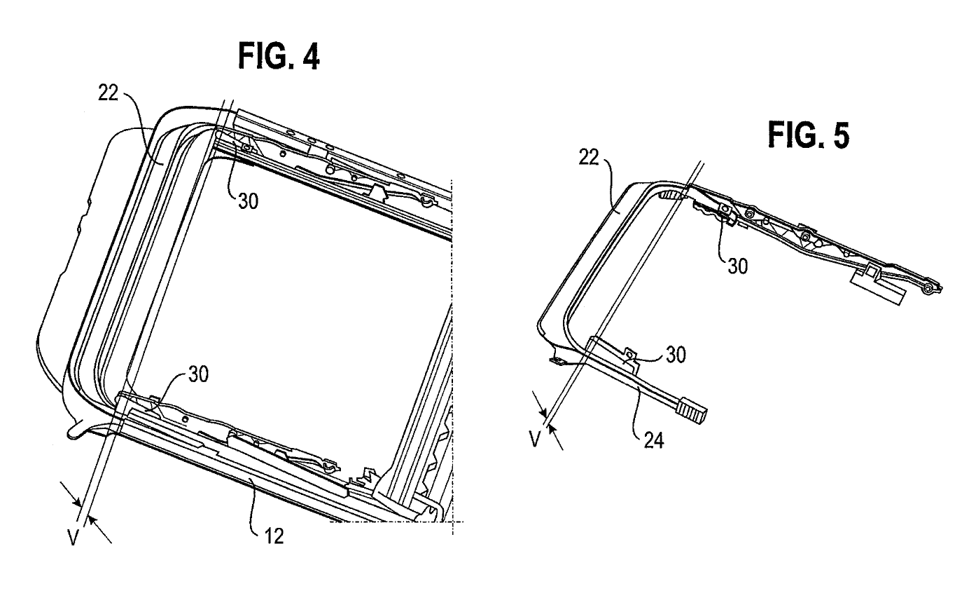

FIGS. 4 and 5 show a sliding roof system according to another example. The same reference numbers are used for the components known from the first example, and reference is made in this respect to the above explanations.

The difference between the first and the second examples is essentially that, in the case of the second example, rather than being arranged on the cover 16, the actuating elements 28 are each arranged on a slide 30 that is part of a mechanism of the sliding roof system 10. However, the manner of operation of the actuating elements 28 is the same as in the first example. When the mechanism of the sliding roof system 10, and therefore the cover 16 are moved towards the closed position, they are displaced forwards to such an extent that they run onto the coupling arms 24 of the wind deflector 20. This presses the wind deflector 20 downwards out of the deployed position into the lowered position. Also, in the case of the second example, an offset V is provided between the two actuating elements 28. The actuating elements 28 are designed here as a lateral projection on the slides 30.

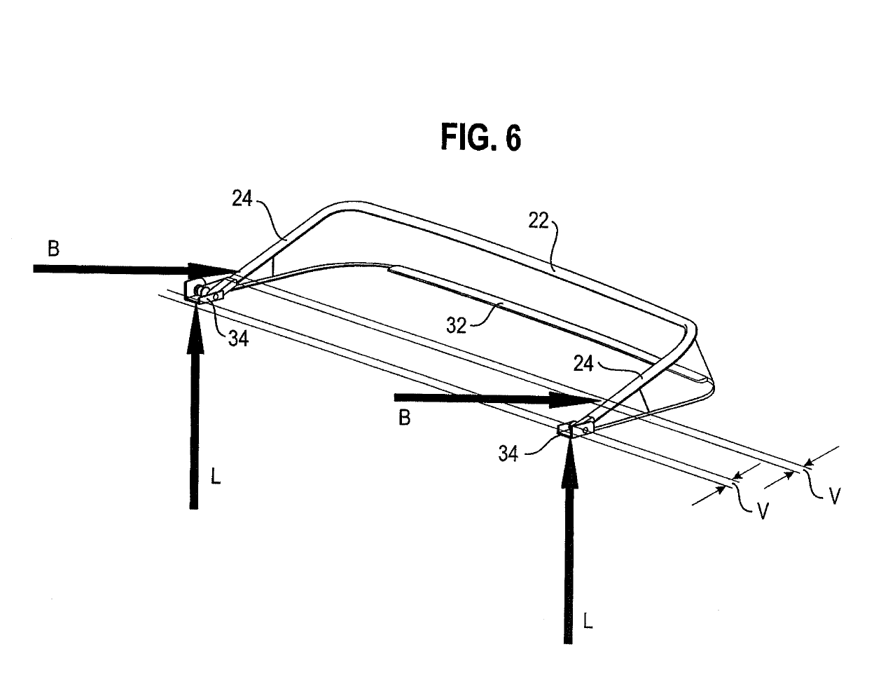

FIG. 6 schematically shows a wind deflector 20 for a third example of a sliding roof system 10. The same reference numbers are used for the components known from the first example, and reference is made in this respect to the above explanations.

A difference between the third example and the previous examples is that the wind deflector 20 of the third example is a “net-type wind deflector.” In the case of this wind deflector 20, a net made of plastic material is fitted on the transverse part 22 of the two coupling arms 24 and extends downwards to a securing part 32. The securing part 32 is secured below the vehicle roof in a region of the guide rails 12.

One main difference between the third example and the two previous examples is that the two coupling arms 24 are coupled to the guide rails 12 at different positions. Two bearing blocks 34 are fitted in the region of the guide rails 12 and can be seen in FIG. 6. One of the bearing blocks 34 is arranged further to the rear than the other, as viewed in the direction of travel and in the longitudinal direction of the guide rails 12. This produces an offset V between the two bearing block positions indicated by arrow L, and therefore also produces an offset between the pivot axes of the coupling arms 24. As such, the coupling arm 24 that is coupled further to the rear than the other arm is of a longer design and also extends with a slightly lesser inclination. During the closing of the cover 16, the two actuating elements 28, which can be fitted on the cover 16 or on a slide, now meet the two coupling arms 24 at different times. The actuating element that is assigned to the coupling arm 24 coupled further to the rear (the right coupling arm in FIG. 6) interacts therewith earlier than the other actuating element. These different positions, which again lead to an offset V, are denoted in FIG. 6 by the arrows B.

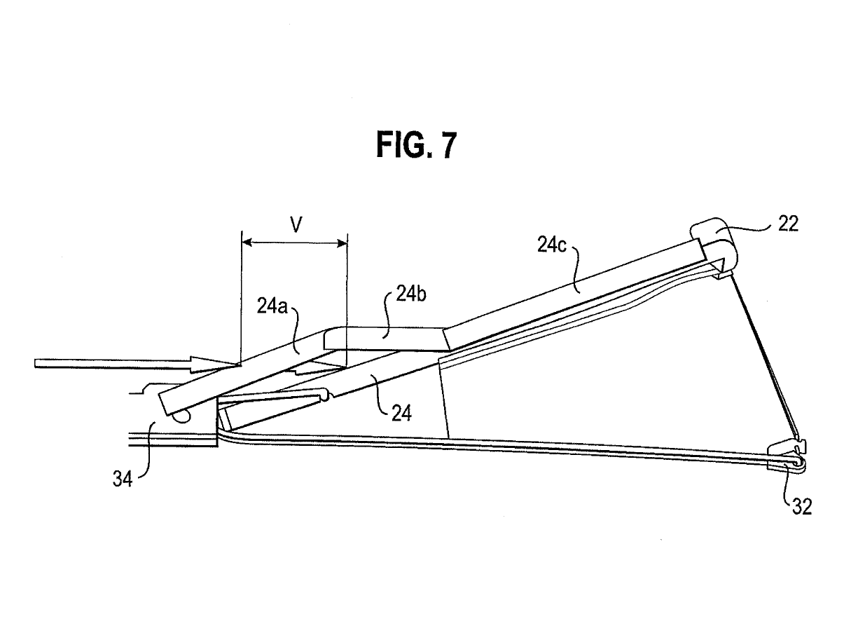

FIG. 7 shows another example of a wind deflector 20 for a sliding roof system 10. The wind deflector 20 is similar to the wind deflector shown in FIG. 6. Also in the case of this example, the two coupling arms 24 are coupled in a manner offset in relation to each other by the bearing blocks 34.

The difference from the third example is that one of the coupling arms 24, i.e. the coupling arm that is situated further forwards with respect to a plane of the drawing (forward coupling arm), is bent rather than being designed rectilinearly. This forward coupling arm comprises a first section 24a that is coupled to the bearing block 34 and extends parallel to the rear coupling arm 24, an intermediate section 24b that extends approximately horizontally in the deployed position of the wind deflector 20, and a second section 24c. The second section 24c extends from the intermediate section 24b to the transverse part 22. The first and the second sections 24a, 24b extend parallel to each other in this example.

Owing to the offset V between the regions of the two coupling arms 24 that interact with the actuating elements 28, i.e. the lower section of the rear coupling arm 24 which is coupled to the bearing block 34 and the first section 24a of the front coupling arm, the two actuating elements 28 strike against the coupling arms in a manner offset in relation to each other. This has the effect that the forward coupling arm, which is of bent design, is pressed downwards followed only later by the rear coupling arm coupled further forwards, as seen in the direction of travel.

A common feature of all of the examples is that, during the closing of the cover 16, and therefore during the movement of the wind deflector 20 from the deployed position into the lowered position, the coupling arms 24 of the wind deflector 20 are displaced slightly obliquely. This is necessarily the consequence of one of the coupling arms 24 being pressed downwards earlier than the other. However, this slight oblique position of the transverse part 22 is not critical because of the inherent elasticity of the wind deflector 20. In addition, it is of such small magnitude that it is usually not noticed by a vehicle occupant. In principle, however, the offset and the resultant oblique position of the transverse part 22 are to be kept as small as possible in order to limit torsional loadings of the transverse part 22. An excessive oblique position of the transverse part 22 could stand out rather negatively if it is noticed by a vehicle occupant. However, the offset should be of sufficient magnitude such that it is greater than the maximum positional tolerance of the interacting components that arises during operation, so that the offset provided by the design and the resultant delay during the pressing down of the two coupling arms is not accidentally eliminated by the tolerances which occur.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A sliding roof system comprising:
a cover that can be displaced relative to at least one guide rail;
a wind deflector that can be displaced between a lowered and a deployed position;
at least two actuating elements that can act on the wind deflector in order to press the wind deflector out of the deployed position into the lowered position; and
an offset V that allows one of the at least two actuating elements to act on the wind deflector while the other of the at least two actuating elements is still spaced apart from the wind deflector.

2. The sliding roof system according to claim 1, wherein the wind deflector has two coupling arms, the two coupling arms being different from each other to produce the offset V.

3. The sliding roof system according to claim 2, wherein each of the two coupling arms is coupled to one guide rail at a coupling point, with the coupling points being offset in relation to each other, as viewed in a longitudinal direction of the guide rails.

4. The sliding roof system according to claim 2, wherein one of the two coupling arms is inclined steeper than the other of the two coupling arms in a region that interacts with an associated one of the at least two actuating elements, such that the offset V is produced when the at least two actuating elements strike against the two coupling arms.

5. The sliding roof system according to claim 1, wherein the at least two actuating elements are fitted on the cover and are offset in relation to each other.

6. The sliding roof system according to claim 1, wherein the at least two actuating elements are fitted displaceably on associated guide rails and are offset in relation to each other.

7. The sliding roof system according to claim 1, including a spring that pushes the wind deflector into the deployed position.

8. A method for displacing a wind deflector of a sliding roof system from a deployed position into a lowered position comprising:
displacing two actuating elements to act on a wind deflector and press the window deflector out of a deployed position and into a lowered position;
having one of the two actuating elements acting on the wind deflector to begin pressing the wind deflector in a direction of the lowered position; and
subsequently having the other of the two actuating elements also acting on the wind deflector to press the wind deflector into the lowered position.
